(19) United States
(12) Patent Application Publication
(10) Pub. No.: US 2003/0112843 A1
(43) Pub. Date: Jun. 19, 2003

(54) Method and apparatus for mode-locked vertical cavity laser with equalized mode response

(75) Inventors: Robert L. Thornton, Los Altos, CA (US); John E. Epler, Milpitas, CA (US)

Correspondence Address: SIERRA PATENT GROUP, LTD., P O BOX 6149, STATELINE, NV, 89449, US

(73) Assignee: Siros Technology, Inc.

(21) Appl. No.: 10/189,201

(22) Filed: Jul. 3, 2002

Related U.S. Application Data
(63) Continuation-in-part of application No. 09/817,362, filed on Mar. 20, 2001.
(60) Provisional application No. 60/263,060, filed on Jan. 19, 2001.
(60) Provisional application No. 60/303,477, filed on Jul. 6, 2001.

(51) Int. Cl. H01S 3/08; H01S 3/082

(52) U.S. Cl. 372/97; 372/96

(57) ABSTRACT

A multi-frequency light source is disclosed. In one disclosed aspect, the light source may comprise a gain region defined by a first and second mirror. The gain region may have corresponding resonant modes. An external cavity defined by a third mirror and said second mirror is also provided, with the external cavity having a plurality of resonant modes. The second mirror may be terminated with a layer of high reflectivity. In a further aspect, the second mirror may be terminated with an antiphase layer.

### BACKGROUND OF THE INVENTION

I. Field

The present disclosure relates to Vertical Cavity Surface Emission Lasers (VCSELs).

II. Background

Fiber optical networks are becoming increasingly faster and more complex. Key to this expansion are technologies such as Vertical Cavity Surface Emission Lasers (VCSELs) because of their ability to generate multiple frequencies of light simultaneously. VCSELs are typically configured to emit multiple channels of energy spaced about the ITU grid.

As is known by those skilled in the art, VCSEL are currently favored over competing technologies such as edge-emitting lasers because VCSELs may be tested while still in wafer form, while edge-emitting laser typically must be dice-cut prior to testing. This is because edge-emitting lasers must be cleaved in order to emit light, while VCSELs do not require cleaving and may emit light while still in wafer form.

However, one challenge to the implementation of VCSELs in modern systems is that current VCSELs may operate well at some wavelengths but not at others. Additionally, some VCSELs may display instability or poor tunability.

Two typical specifications for VCSEL-based systems are channel frequency spacing and number of channels. The product of these two represents the emission bandwidth and is therefore an essential requirement for any VCSEL device.

As is appreciated by those skilled in the art, the ultimate limit on emission bandwidth is given by the gain bandwidth of the quantum well region. The gain bandwidth of a typical quantum well region also has a non-ideal response shape that is non-rectangular in nature which results in additional system costs and increased power requirements.

Hence, there is a need for a multi-channel light source that does not suffer from the deficiencies of the prior art.

### SUMMARY

A multi-frequency light source is disclosed. In one disclosed aspect, the light source may comprise a gain region defined by a first and second mirror. The gain region may have corresponding resonant modes. An external cavity defined by a third mirror and said second mirror is also provided, with the external cavity having a plurality of resonant modes. The second mirror may be terminated with a layer of high reflectivity. In a further aspect, the second mirror may be terminated with an antiphase layer.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a conceptual diagram of one aspect of a disclosed multi-frequency light source;

FIG. 2 is a more detailed conceptual diagram of one aspect of a disclosed multi-frequency light source;

FIG. 3 is a plot of the resonant modes of one aspect of a disclosed system;

FIG. 4 is another plot of the resonant modes of one aspect of a disclosed system;

FIG. 5 is a conceptual plot of the resonant modes of one aspect of a disclosed system;

FIG. 6 is a plot comparing 23 and 7 layer pair structures with and without an antiphase layer;

FIG. 7 an experimental plot showing a mirrored structure with 7 pairs; and

FIG. 8 is a plot of the reflectivity spectrum of a free standing mirror M2 with 7 layer pairs, a free standing mirror with 17 layer pairs, and an antiphase layer.

### DETAILED DESCRIPTION

Persons of ordinary skill in the art will realize that the following description of the present invention is illustrative only and not in any way limiting. Other embodiments of the invention will readily suggest themselves to such skilled persons having the benefit of this disclosure.

The following references are hereby incorporated by reference into the detailed description of the preferred embodiments, and also as disclosing alternative embodiments of elements or features of the preferred embodiment not otherwise set forth in detail above or below or in the drawings. A single one or a combination of two or more of these references may be consulted to obtain a variation of the preferred embodiment described above. In this regard, further patent, patent application and non-patent references, and discussion thereof, cited in the background and/or elsewhere herein are also incorporated by reference into the detailed description with the same effect as just described with respect to the following references:

U.S. Pat. Nos. 5,347,525, 5,526,155, 6,141,127, and 5,631,758;

Wilmsen, Temkin and Coldren, et al., “Vertical Cell Surface Emitting Lasers, 2nd edition;

Ulrich Fiedler and Karl Ebeling, “Design of VCSELs for Feedback Insensitive Data Transmission and External Cavity Active Mode-Locking”, IEEE JSTQE, Vol. 1, No. 2 (June 1995); and

J. Boucart, et al., 1-mW CW-RT Monolithic VCSEL at 1.55 mm, IEEE Photonics Technology Letters, Vol. 11, No. 6 (June 1999).

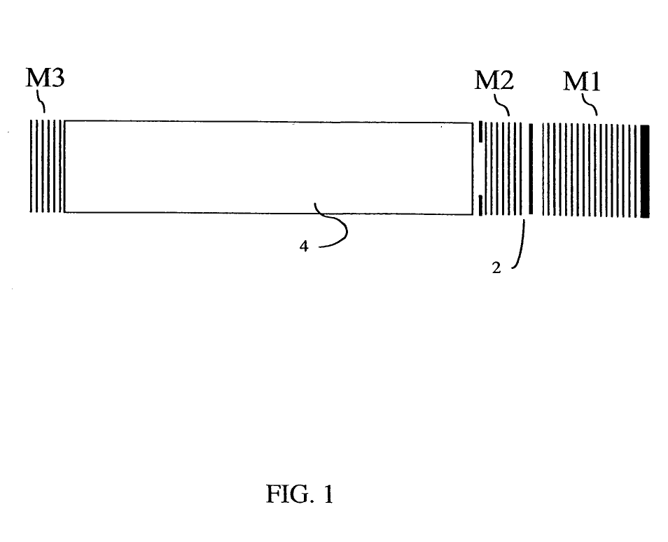

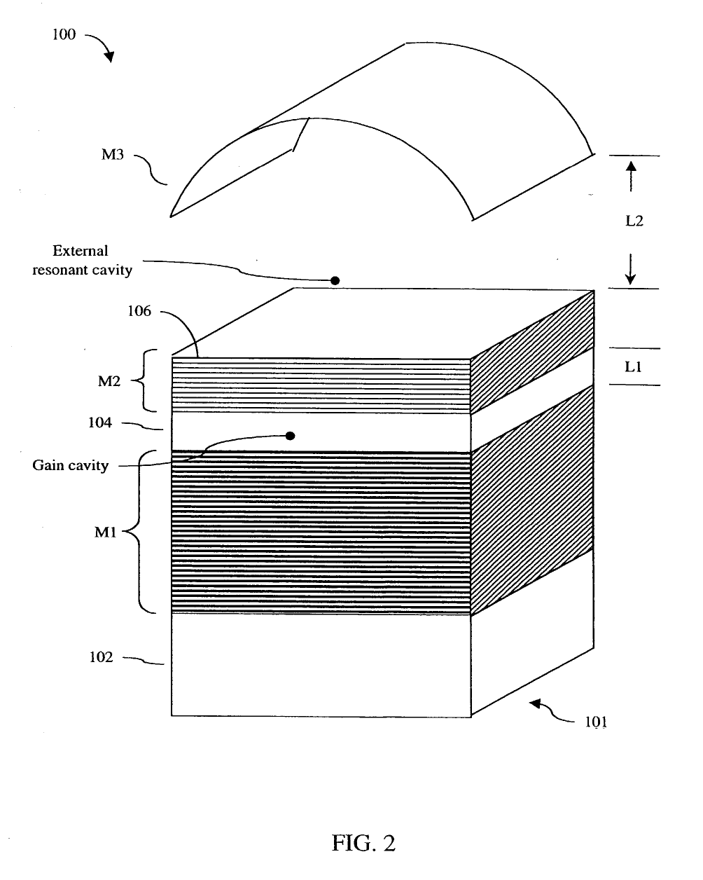

FIG. 1 is a conceptual diagram of a multichannel light source and illustrates a three-mirror composite-cavity VCSEL configured in accordance with the teachings of this disclosure. The light source includes epitiaxially-grown mirrors M1 and M2, and an external mirror M3. In operation, mirror M3 controls frequency spacing between mode-locked modes by way of its distance from M2 and M3 (representing a cavity length L2, as shown in FIG. 2), and provides output coupling of the laser energy. The combination of these mirrors defines two cavities: the VCSEL resonant cavity 2, or gain cavity 2, defined by M1 and M2; and an external cavity 4 defined by M2 and M3.

FIG. 2 is a more detailed conceptual diagram of one aspect of a disclosed multifrequency light source 100. The light source 100 may include a VCSEL 101 having a substrate 102 for reflecting light at normal incidence. The substrate 102 may be formed from materials known in the art such as Gas or InP depending on the desired wavelength.

On top of the substrate 102 a mirror M1 is formed. The layers of M1 may be formed epitaxially using techniques known in the art. If the substrate 102 comprises GaAs, then the layers of M1 may be formed from alternating layers of GaAs/InGaAs for use in the wavelength range of 780-980 nm. Alternatively, if the substrate 102 comprises InP, the layers of M1 may formed of alternating layers of InGaAlAs/InP for use in the wavelength range of 1300-1700 nm.

An active layer 104 for amplifying light is then grown on M1. The active layer 104 may comprise a quantum well active layer fashioned from the same materials as M1. The active layer 104 will have a gain response and a nominal peak frequency associated therewith. In one aspect of a disclosed light source, the active layer 104 may have a nominal peak frequency of 1550 nm. The nominal peak frequency are typically functions of variables such as current or temperature.

A mirror M2 may then be grown on the active layer 104 using techniques similar to M1. The active layer 104, combined with mirror layers 102 and M3 comprise a resonant cavity for which can be associated an effective cavity length L1.

The light source 100 may further include a mirror M3 disposed a distance L2 from the upper surface of M2.

A multifrequency light source 100 is thus formed including a VCSEL 101 and an external mirror M3 wherein several alternative designs and variations may be possible. The light source 100 may be described in terms of the distance L1 between mirrors M1 and M2 forming a gain cavity and the distance L2 between mirrors M2 and M3 forming an external cavity.

In general, the cavity length of the external cavity may be greatly extended compared with a conventional VCSEL device. The external cavity may be, e.g., between a few hundred microns and several millimeters, and is particularly preferred around 2-3 mm in physical length for a mode-spacing of 50 GHz. For example, at 50 GHz and for a refractive index n=1 (such as for an air or inert gas filled cavity), then the cavity will have a physical length L2 of about 3 mm, which provides a 3 mm optical path length corresponding to 50 GHz. The actual cavity length to achieve 50 GHz may also depend on the reflective indices of the media between M2 and M3. For example, for a cavity material such as glass, e.g., n=1.5, then the physical length will be around 2 mm to provide the optical path length of 2 mm×1.5=3 mm, again corresponding to a 50 GHz mode spacing.

The distance L2 and thus the cavity length may be increased to reduce the mode-spacing. For example, by doubling the cavity length, e.g., to 4-6 mm, the mode-spacing may be reduced to 25 GHz, or by again doubling the cavity length, e.g., to 8-12 mm, the mode-spacing may be reduced to 12.5 GHz. The mode-spacing may be increased, if desired, by alternatively reducing the cavity length, e.g., by reducing the cavity length to half, e.g., 1-1.5 mm to increase the mode-spacing to 100 GHz. Generally, the mode-spacing may be advantageously selected by adjusting the cavity to a corresponding cavity length. The device of the preferred embodiment may utilize other means for reducing the mode-spacing as understood by those skilled in the art.

This extension of cavity length from that of a conventional VCSEL is permitted by the removal or partial removal of a mirrored reflector surface of the mirror M2 and inclusion of mirror M3. The light source 100 and in particular the mirror M3 may be formed as disclosed in co-pending application Ser. No. 09/817,362, filed Mar. 20, 2001, and assigned to the same assignee of the present application, and incorporated by reference as though set forth fully herein.

The extension of the external cavity out to 1.5-15 mm permits a 10-100 GHz mode spacing, since the cavity will support a number of modes having a spacing that depends on the inverse of the cavity length (i.e., c/2 nL, where c is the speed of light in vacuum, n is the refractive index of the cavity material and L is the cavity length). The VCSEL with external cavity device for providing multiple channel signal output according to a preferred embodiment herein is preferably configured for use in the telecom band around 1550 nm, and alternatively with the telecom short distance band around 1300 nm or the very short range 850 nm band. In the 1550 nm band, 100, 50 and 12.5 GHz cavities are of particular interest as they correspond to standard DWDM channel spacings.

The monolithic portion of the light source 100 may be around 15 microns tall when formed on a substrate 100-700 μm thick and preferably comprises a gain medium of InGaAsP or InGaAs and InGaAlAs or In GaAsP or AlGaAs mirrors (or mirrors formed of other materials according to desired wavelengths as taught, e.g., in Wilmsen, Temkin and Coldren, et al., “Vertical Cavity Surface Emitting Lasers, 2nd edition, Chapter 8).

The light source 100 may be formed in a variety of manners. For example, the second mode spacing cavity may be formed by a solid lens of either conventional or gradient index design, and may be formed of glass. When a gradient index lens is used, the index of refraction of the material filling the cavity varies (e.g., decreases) with distance from the center optical axis of the resonant cavity. Such GRIN lens provides efficient collection of the divergent light emitted from the laser cavity. In an embodiment using a GRIN lens, the mirrored surface of mirror M3 may be curved or flat, depending on design considerations.

The mirror M3 may have one or more coatings on its remote surface such that it efficiently reflects incident light emitted from the VCSEL 101 as a resonator reflector, preferably around 1550 nm for the telecom band. The mirror M3 is preferably formed of alternating high and low refractive index materials to build up a high reflectivity, such as alternating quarter-wavelength layers of TiO2/SiO2 or other such materials known to those skilled in the art.

The radius of curvature of the lens may be around the length the second cavity. Emitted radiation from the VCSEL 101 will diverge outward from the gain region substantially be reflected directly back into the gain region when the radius of curvature is approximately the cavity length, or around 2-3 mm for a 50 GHz mode-spacing device.

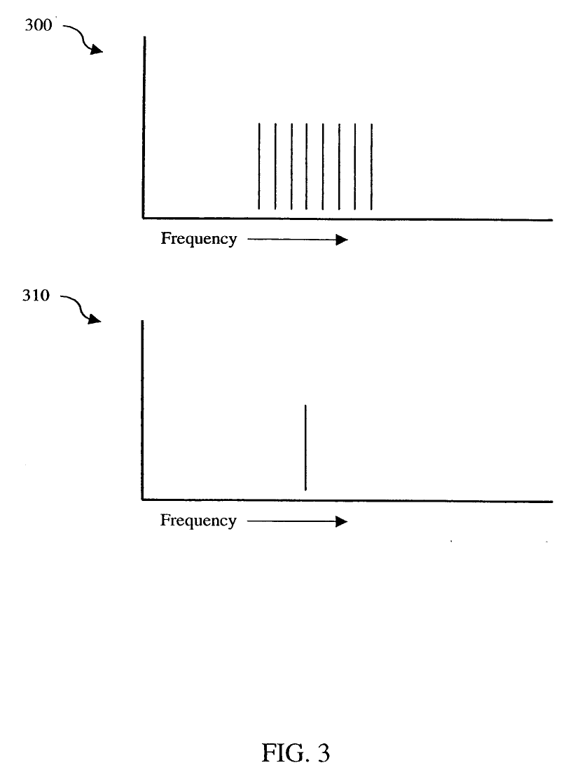

The two cavities of the light source 100 will each have corresponding resonant modes associated therewith, as illustrated in FIG. 3. The resonant modes for the external cavity defined by the distance L2 are shown as plot 300, and corresponding resonant mode plot for the gain cavity defined by the distance L1 is shown as plot 310.

In operation, the cavities provide one or more resonant modes at optical frequencies for which the roundtrip gain exceeds the loss. For a longer cavity such as the external cavity, the resonant modes form a comb of frequencies having a separation inversely proportional to the cavity length. For example, for a cavity optical length of 3 mm, the optical spacing of the modes is approximately 50 GHz. The light amplifying active layer will typically have a gain bandwidth of 2-4 THz (2000-4000 GHz). Thus, many such modes will fit within the gain bandwidth of the gain material.

However, the gain cavity of the VCSEL gain cavity typically has a micron-scale optical length and thus a much greater modal spacing, typically in the multi-THz range. Since L2>>L1, many more resonant modes will occur in the external cavity in a given frequency spectrum than will occur in the gain cavity. In fact in the typical instance, there may be only one resonant mode in the first cavity which falls in the corresponding gain bandwidth of the laser, as is illustrated in FIG. 3.

Thus, typically only one resonance will exist in the gain bandwidth. The breadth of this resonance depends on the values of M2 and M3 and may range from a few GHz to 1 THz.

When the two cavities defined by (M1 and M2) and (M2 and M3) are put together, they must jointly satisfy roundtrip phase boundary conditions for laser operation. If the modes of the second cavity do not overlap with at least one of the modes of the first cavity, then laser emission will not be achieved.

Thus, when combining the fine comb frequencies of an external cavity with the single resonance of a VCSEL gain cavity, lasing may be limited to cavity resonances which lie within the resonant bandwidth of the VCSEL gain cavity. The width of the resonance of the VCSEL cavity may be varied by varying M1 and M2, such that the gain cavity resonance can span multiple external resonances.

Two typical specifications for VCSEL-based systems are channel frequency spacing and number of channels. The product of these two represents the emission bandwidth and is therefore an essential requirement for any VCSEL device.

The response of the device thus depends on the relative reflectivity of the mirrors, the gain response and bandwidth of the amplifying region, and the relationship between the resonances of the gain regions of both cavities.

In one aspect of a disclosed multi-frequency light source, the spectral bandwidth of the light source may be controlled by varying the reflectivity of M2. The reflectivity of M2 may be controlled by altering the number of layer pairs used to form the mirror. As the reflectivity of M2 is decreased, the spectral bandwidth will increase.

One of the key goals in the design of any communication system is to achieve as flat as response as possible from channel to channel.

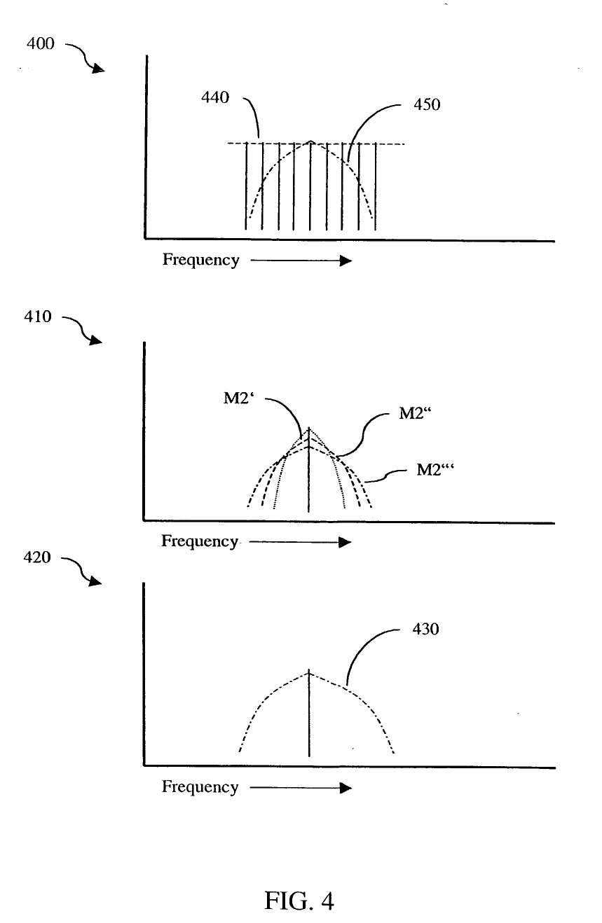

FIG. 4 is shows a series of plots illustrating how the final output response of a multi-channel light source may be determined. Plot 420 shows the gain response 430 versus frequency of the gain cavity. The response 430 will typically have a peak at a center frequency. As is known by those skilled in the art, the response shape of plot 420 can be difficult to influence.

Plot 410 is a conceptual plot showing how the reflectivity of M2 may be adjusted to achieve mode selectivity. Plot 410 includes the resonant modes of an external cavity and illustrates how varying the reflectivity of the gain cavity may result in different responses M2′, M2″, and M2″′. By analogy to the electrical arts, by varying the Q of the gain cavity, the resonant bandwidth of the gain cavity may be selected advantageously. As the reflectivity of the mirror is reduces, the resonance flattens out, as in a lower-Q circuit.

As will be appreciated from plot 410, by varying the reflectivity of M2, the spectral bandwidth of the gain cavity may be chosen so as to have a predetermined response shape. By varying the response shape of the mirror M2, the response of the gain cavity may be shaped as desired so as to overlap or intersect one or more of the resonant modes of the external cavity.

Plot 400 shows how the response of the gain cavity and the spectral response of M2 may combine to produce a final output. Ideally, the external cavity produces a spectrum of allowed modes having a flat response as illustrated by response 440. However, the gain cavity and M2 may combine to influence the external cavity's mode spectrum and produce a peaked output as illustrated by response 450. Thus, the individual responses of the gain cavity and M2 are superimposed on the mode spectrum of the external cavity.

As illustrated above, while the gain shape of the gain cavity may be difficult to influence, the spectral response of M2 may be more convenient to influence. This is because the reflectivity properties of M2 are determined by how the layers of M2 are grown when M2 is formed. The reflectivity properties of the mirror M2 when plotted may be viewed as a ‘passband’ with the shape of the passband depending on how the layers are formed.

Typically, M2 is formed using alternating ¼-wavelegnth layers of alternating high and low refractive materials, e.g., n-high, n-low, n-high, etc. Furthermore, typical designs terminate the mirror with the n-low layer, since this results in the highest peak reflectivity.

In one aspect of a disclosed multi-frequency light source, the mirror M2 may be terminated with one addition ¼-wavelength layer of n-high. By choosing the final layer, the reflectivity response of the mirror M2 may be tailored to match the response of the passband.

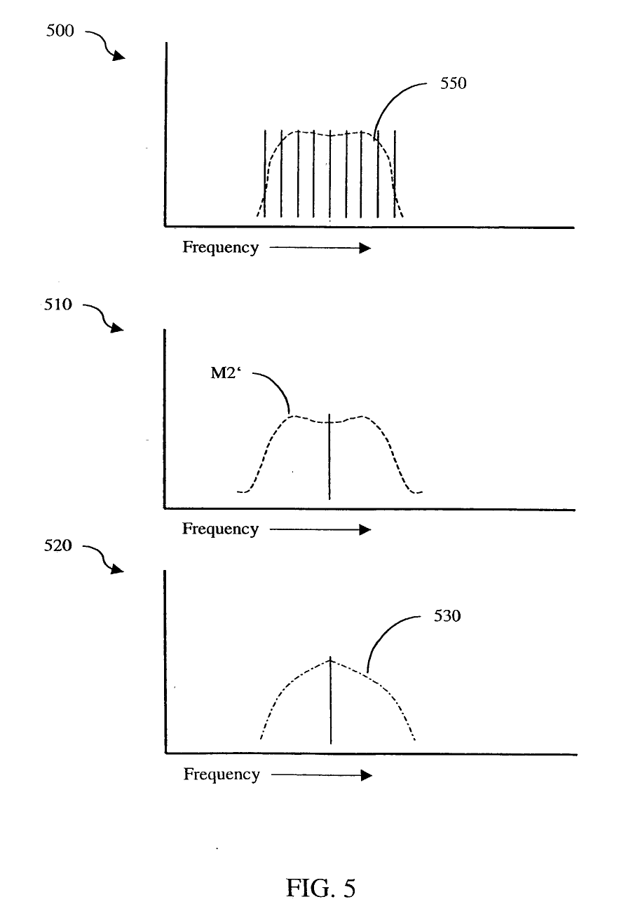

FIG. 5 is a series of conceptual plots illustrating how the final response of a light source may be improved by terminating the final layer of M2 with a n-high material. Plot 520 shows the gain response 530 of the gain cavity as described above.

Plot 510 shows how the spectral passband response M2′ of the mirror M2 is changed by terminating the final layer with a n-high material, resulting in a square shape having ‘wings’ at each frequency extreme and a trough located at the center of the response. In other words, the response of M2′ may be said to have a local minimum interspersed between a pair of local maximums.

When the peaked gain response 530 is superimposed over the winged passband M2′, the result is response 550 of plot 500. As will be appreciated from FIG. 5, the response shape of M2′ may be chosen to compensate for the gain response by choosing a response shape that is substantially complimentary in shape to the gain response. As will be appreciated by those skilled in the art, perfectly complimentary shapes may be difficult or impractical to achieve. Thus, the response shape of M2′ may be chosen to be as complimentary in shape to the gain response as is desired. By so configuring the responses of the external and gain cavities, the response 550 may have a shape that is much closer to the ideal flat response 450 of FIG. 4.

In a further aspect, M2 may be modified by adding a final terminating quarter wavelength antiphase layer. This layer brings the surface reflection into opposition with the rest of M2, reducing and flattening the gain cavity resonance. It is contemplated that the number of lasing frequencies will therefore increase and the amplitude distribution of the lines will be made more rectangular.

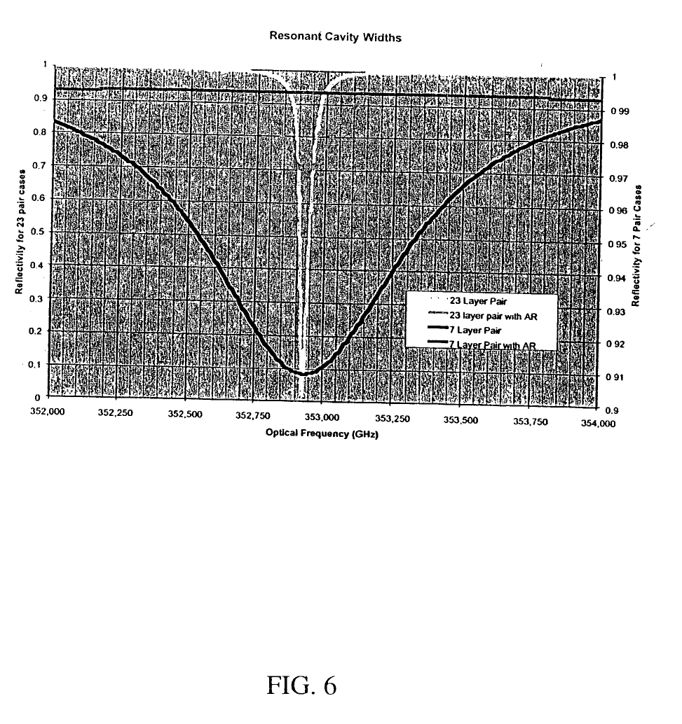

In FIG. 6, 23 and 7 layer pair structures are compared with and without the antiphase layer, and the results are shown as a function of frequency rather than wavelength.

It can be seen that with the 23 layer pair structure, the passband is very narrow, and limited to only approximately 20 GHz. By adding the quarter wave antiphase layer, this bandwidth can be increased to approximately 100 GHz. It is evident from these results that bandwidth in a 23 layer pair structure may be extremely limited, which is why the prior art has characterized VCSELs as being unsuitable for short pulse mode locking. However, if we consider the case of the 7 layer pair structure, we find that the spectral bandwidth is increased to a very useful 350 Ghz without the quarter wave layer, and essentially flatband (or a very broad resonance) with the quarter wavelength layer.

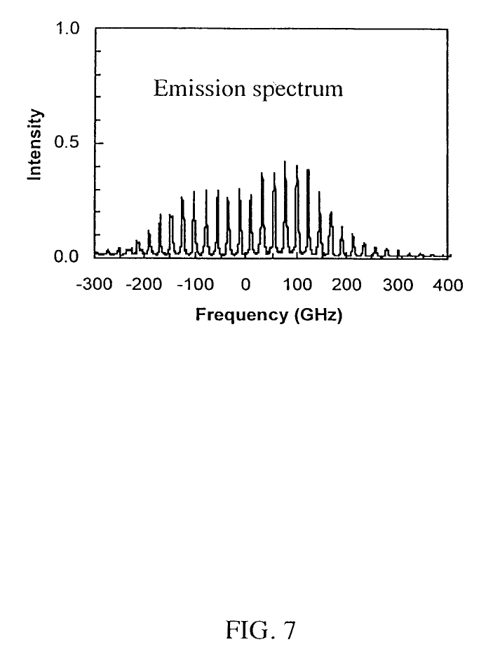

FIG. 7 is an experimental plot showing a structure with M2 at 7 pairs when placed in an external cavity and modelocked. It is found that the spectral bandwidth is determined at approximately 325 GHz as expected, and is relatively insensitive to fluctuations in modelocking power insofar as the number of modes is concerned. Thus by adjusting the “Q” of the gain cavity, the spectral bandwidth for modelocking can be determined, and hence the number of modes that will be locked may also be determined.

It is contemplated that an additional aspect for controlling the frequency bandwidth would be to adjust the spectral width of the mirror coating M3. This technique could be combined with alterations in M2 to achieve the optimum result.

Within the modelocked spectral bandwidth as determined by M2, the relative amplitudes of various modes will be determined by the relative values of their modal gains at threshold. The net modal gain will be a combination of the modal losses and the active layer gain.

The active layer gain will typically have a maximum corresponding to the peak emission wavelength. This peak emission wavelength will correspond to the center of the spectral emission range in an optimized device. The frequency dependence of the modal losses will be dominated by the frequency dependence of the cavity mirror losses. Mirror losses for conventional mirror design will have a minimum at the peak emission wavelength. All other wavelengths (frequencies) of emission will therefore fall off monotonically as frequency deviates from optimal frequency.

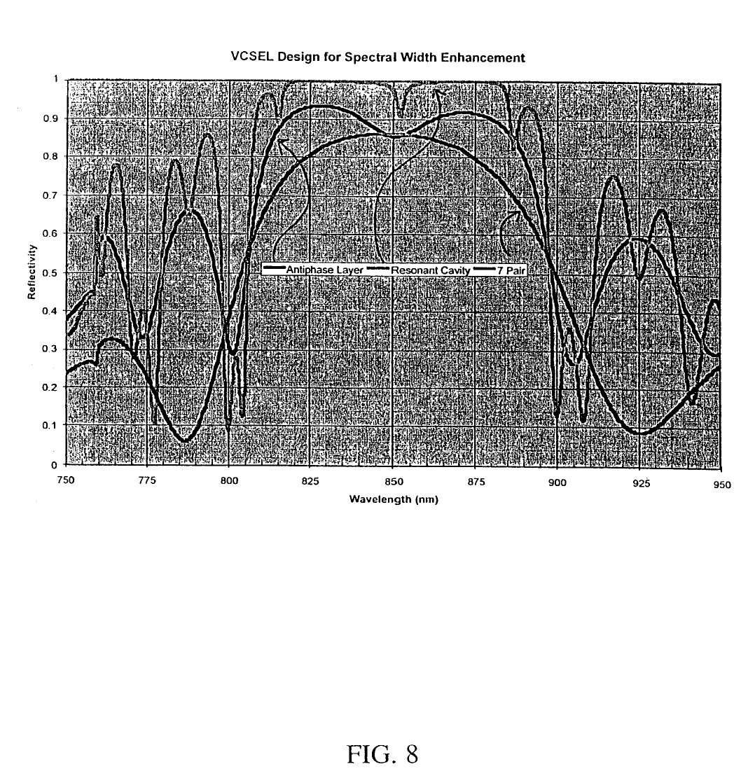

FIG. 8 shows the reflectivity spectrum of a free standing mirror M2 with 7 layer pairs as well as for a free standing mirror with 17 layer pairs, plus an antiphase layer which reduces the total reflectivity. The reflectivity spectrum for a full VCSEL mirror resonant cavity is also shown.

It can be seen that the reflectivity for the antiphase layer case has a local minimum at the center wavelength, as opposed to the conventional mirror which has a local maximum at the center wavelength. The locally increasing reflectivity (decreasing cavity loss) which results can be designed to compensate for the locally decreasing cavity gain, resulting in a broadening of the spectral range over which net cavity losses are uniform. This will result in an increase of the amplitude of the outlying spectral components relative to the central spectral components, which will result in a spectral profile approaching the more desired square profile. In other words, with the mirror structured as disclosed herein, the decrease in gain for frequencies removed from the gain peak is compensated by the increase in reflectivity of M2. This compensation is a result of the lower losses in the gain cavity relative to the external cavity. Thus the lower gain in the wings of the spectral region is matched with a lower loss. This will, in turn, equalize the amplitudes of the modes within the modelocked spectrum.

The previous description of various embodiments, which include preferred embodiments, is provided to enable any person skilled in the art to make or use the present invention. The various modifications to these embodiments will be readily apparent to those skilled in the art, and the generic principles defined herein may be applied to other embodiments without the use of the inventive faculty. Thus, the present disclosure is not intended to be limited to the embodiments shown herein but is to be accorded the widest scope consistent with the principles and novel features disclosed herein.

What is claimed is:

1. An equalized light source comprising:
a gain region defined by a first and second mirror, said second mirror being formed from alternating layers of n-low and n-high materials, and said gain region having a corresponding gain response;
an external cavity defined by a third mirror and said second mirror, said external cavity having a corresponding response shape; and
wherein said second mirror is terminated with a layer of n-high material.

2. The light source of claim 1, wherein a corresponding response of said second mirror and said gain response of said gain region are substantially complimentary in shape.

3. The light source of claim 1, wherein said second mirror is terminated with an antiphase layer.

4. The light source of claim 1, wherein said second mirror comprises a seven-layer structure.

5. The light source of claim 4, wherein said light source has a spectral bandwidth of approximately 325 GHz.

6. The light source of claim 1, wherein said response shape of said external cavity has a local minimum which corresponds to a local maximum of said gain response of said gain region.

7. A light source comprising:
a gain region defined by a first and second mirror, said gain region having a corresponding peaked gain response shape having a local maximum;
an external cavity defined by a third mirror and said second mirror, said external cavity having a corresponding response shape defined by a passband having a local minimum interspersed between a pair of local maximums; and
wherein a corresponding response of said second mirror is chosen so as to form a substantially flat output response when superimposed over said peaked gain response shape.

8. The light source of claim 7, wherein said corresponding response of said second mirror and said gain response shape of said gain region are substantially complimentary in shape.

9. The light source of claim 7, wherein said second mirror is terminated with an antiphase layer.

10. The light source of claim 7, wherein said second mirror comprises a seven-layer structure.

11. The light source of claim 10, wherein said light source has a spectral bandwidth of approximately 325 GHz.

12. The light source of claim 7, wherein said local minimum corresponds to said local maximum of said gain response shape of said gain region.

13. A light source comprising:
a gain region defined by a first and second mirror, said gain region having a corresponding peaked gain response shape having a local maximum;
an external cavity defined by a third mirror and said second mirror, said external cavity having a corresponding response shape defined by a passband having a local minimum interspersed between a pair of local maximums; and
wherein a corresponding response of said second mirror is chosen so as to be substantially complimentary in shape when compared to said peaked gain response.

14. The light source of claim 13, wherein said second mirror is terminated with an antiphase layer.

15. The light source of claim 13, wherein said second mirror comprises a seven-layer structure.

16. The light source of claim 15, wherein said light source has a spectral bandwidth of approximately 325 GHz.

17. The light source of claim 13, wherein said local minimum corresponds to said local maximum of said gain response shape of said gain region.
